(19) United States
(12) Patent Application Publication
(10) Pub. No.: US 2007/0047867 A1
(43) Pub. Date: Mar. 1, 2007

(54) Downhole fiber optic acoustic sand detector

(76) Inventor: Eric L. Goldner, Valencia, CA (US)

Correspondence Address: John K. Fitzgerald;Fulwider Patton, Howard Hughes Center, 6060 Center Drive, Tenth Floor, Los Angeles, CA, 90045, US

(21) Appl. No.: 10/574,329

(22) PCT Filed: Sep. 30, 2004
(86) PCT No.: PCT/US04/32114

§ 371 Date: Mar. 31, 2006

Related U.S. Application Data
(60) Provisional application No. 60/508,383, filed on Oct. 3, 2003.

(51) Int. Cl. G02B 6/00

(52) U.S. Cl. 385/12; 385/37

(57) ABSTRACT

An array of fiber optic acoustic sensors is formed within an optical fiber. The array of acoustic sensors may be deployed to a well bore for detecting acoustic signals occurring within the production area of the well bore, such as acoustic signals resulting from sand invading the well bore. A plurality of acoustic sensors may be formed by forming a plurality of periodic refractive index perturbations at selected intervals within the acoustic sensing section of the optical fiber. The optical fiber may be deployed within the well head within a suitable protective arrangement such as deployed through a tube or armor using a suitable material such that the optical fiber is protected, yet retains sensitivity to acoustic signals. The fiber optic acoustic sensor of the present invention may be unobtrusively mounted on the exterior of a well casing such that the sensor is not in the fluid stream.

### CROSS-REFERENCES TO RELATED APPLICATIONS

This application claims the benefit of priority to U.S. Provisional Application No. 60/508,383, filed Oct. 3, 2003, the subject matter of which is being incorporated herein in its entirety.

### FIELD OF THE INVENTION

The present invention relates generally to a system and method for sensing the invasion of an oil or gas well by sand suspended in the fluid or gas being pumped from the well. More specifically, the present invention relates to a rugged and unobtrusive acoustic sensor incorporating one or more acoustic sensing regions which may include one or more hydrophones formed using lengths of optical fibers separated by fiber Bragg gratings that act as partially reflective mirrors to separate the acoustic sensing regions. One or more acoustic sensing sections may be attached to a lead cable and lowered deeply into the well bore. The acoustic sensing regions, or hydrophones, are connected to the surface by the fiber optic cable that is incorporated into the lead cable. An optical interrogator at the surface transmits and receives light into and out of the fiber optics and analyzes the changes in the intensity of the light returned from the hydrophones. Sand is detected by comparing the acoustic signature of the flow stream with and without sand.

### BACKGROUND OF THE INVENTION

It is well known in the petrochemical industry that the fluid pumped from wells may be contaminated with sand. In a typical well, the deep end of the downhole bore includes a casing that is perforated to allow oil or gas to seep into the well, where it may flow or be pumped to the surface. If oil or gas entering the perforations contain significant amounts of suspended sand, the resulting contaminated and abrasive fluid may cause significant damage to the well's production equipment, both in the bore of the well and at the surface, possibly requiring the well to be shut down and repaired. Depending on the depth and construction of the well, as well as the amount of damage to the well's equipment, such repairs may result in taking the well off line for a significant amount of time, and costing hundreds of thousands to millions of dollars to repair.

Various techniques have been developed for determining the presence of particulate solids such as sand in a fluid flowstream. One area of endeavor in which the detection of sand volume or mass flow rate or fracture proppant flow rate is important is in oil and gas production. The monitoring of sand or fracture proppant flow is critical to minimizing excess wear on fluid piping and other flow control components and to control proper production rates from a subterranean reservoir.

Presently, many wells employ sand sensors at the well head that can reliably detect sand via acoustic methods. The disadvantage of these systems, however, is that in a high percentage of wells, typically deeper, more expensive wells, significant damage may occur to the well equipment before the sand reaches the well head where it can be detected. For example, in a typical deep well, sand entering the production stream will not be sensed at the well head for approximately thirty or more minutes. During this period of time, actions could be taken to halt the flow of fluid within the well so as to protect the well bore equipment from damage, or, at the very least, to limit the damage that occurs.

U.S. Pat. No. 3,841,144 to Baldwin; U.S. Pat. No. 3,854,323 to Hearn et al; U.S. Pat. No. 4,240,287 to Mast et al; and U.S. Pat. No. 4,674,337 to Jonas, which are hereby incorporated by reference herein in their entirety, describe examples of the prior art in acoustical sand detector devices and methods. An article entitled “Acoustic Measurements Detect Sand in North Sea Flowlines” by Folkestad et al, Oil and Gas Journal, Aug. 27, 1990, and a paper entitled “New Instrumentation for Managing Sand Problem Prone Fields” by Stuivenwold et al, SPE No. 9368 by the American Institute of Mining, Metallurgical and Petroleum Engineers, Inc., Sep. 21-24, 1980, which are hereby incorporated by reference herein in their entirety, also describe acoustic sand detection methods.

The Baldwin patent describes an acoustic type detection probe which may be inserted in a fluid flowline and which transmits particle impacts to a piezoelectric type sensor, the output of which is filtered and rectified and compared with a reference signal to provide an output signal indicating the presence of sand in the flowline. In the Hearn patent, sand concentration is measured in a flowline with an acoustic detector wherein the output signal is amplified at two frequencies and resultant signals are combined electronically in such a way that the output signal is a function of sand concentration and nearly independent of fluid flow velocity. The Mast, et al. patent also describes an acoustic type sand detector wherein the output signal from the detector probe is subjected to a signal pulse height discriminator and pulse counter to determine sand or other particulate flow rates. The Jonas patent describes an arrangement of a sand detector probe for a fluid flowline together with noise compensating probes, also attached to the flowline, for subtracting extraneous signal noise from the output signal of the sand detector probe.

The accuracy of the prior art sand detectors described in the above-noted references has not been adequate to make these devices commercially acceptable in many applications. Accordingly, there has been a continuing need to develop a more accurate sand detector which can distinguish the occurrence of sand or other particulate solids flow in a fluid flowstream and that can also accurately determine the flow rate or concentration of sand or particulate solids in the fluid flowstream.

Other systems have been used or suggested for monitoring or detecting said content in a fluid well. For example, in one system, an erosion probe is used to determine abrasion caused by in a fluid flow. In such a system, sand erodes a thin, hollow-walled probe which is mounted in the fluid flow. A measured pressure difference between the fluid flow and a reference point activates an alarm. Due to the slow erosion process, there is typically be a considerable time delay before this probe detects sand. Moreover, the system does not provide continuous monitoring of the sand content in the fluid flow or the sand production rate.

Acoustic probes that either can be clamped on the outside of a pipe wall or mounted inside the pipe are also known. Such a probe can detect sand production in either a gas or a liquid flow. However, such probes lack the sufficient ability to distinguish between sand noise and other noise in intermittent or annular/mist fluid flows. Calibration of the acoustic probe has to be performed with actual production parameters and by injection of sand. However, the calibration changes when the production rate or other sources of noise are varied. Small particles (0-0.5 mm dia.) produce acoustic energy too low to discriminate between particle- and flow noise. One such acoustic probe is described in U.S. Pat. No. 140,838, which is hereby incorporated by reference herein in its entirety.

U.S. Pat. Nos. 3,678,273, 3,767,916 and EP Patent No. 0 317 339, which are hereby incorporated herein by reference in their entirety, disclose various methods for measuring erosion caused by abrasive fluid. Typically, a detector of the type described within these patents is coated with a radioactive material and positioned in a fluid flow, for example an oil slurry. The detector is activated by radiation from the radioactive coating due to a thickness reduction caused by the abrasive fluid, and the detector sends signals to a control and monitoring unit on the outside of the pipe. The particle concentration of the flow is determined by determining the particle in a concentration of an equivalent flow of known composition which causes the measured reduction of radiation emission when it contacts an equivalent material at the measured flow velocity. The particle concentration in the flow can thus be estimated. This method is disadvantageous because the detector is mounted in the flow and will be an obstruction to the flow of produced fluid, such as oil. Moreover, the detector may not be able to detect small particles because these particles will follow the flow and pass around the obstruction, and thus this detector may not be useful in a high pressure hydrocarbon pipe where it is impossible to predict the sand distribution.

What has been needed and heretofore unavailable, is a low cost, yet robust method of detecting sand at the production area of the well so as to provide a warning of sand invasion before the sand can percolate throughout the well stream and damage downhole or well head equipment. The present invention satisfies these and other needs.

### SUMMARY OF THE INVENTION

The present invention provides an improved downhole sand detector system and method for detecting the presence of sand and other particulate solids in fluid flowstreams, and is particularly useful in detecting the invasion of sand into a well bore before the invading sand can damage the well or equipment associated with the well.

In one aspect, the present invention is embodied in a fiber optic acoustic sensor that is capable of operating reliably in the harsh environment of a well bore. The ruggedness and reliability is due in part to the simplicity of the sensor, and in part to the sensor design which allows for the location of expensive, delicate and difficult to repair electronic equipment for analyzing signals from the sensor representing received acoustic signals at the well head surface.

In another aspect, the present invention includes one or more acoustic sensor sections formed in an optical fiber, with each sensor section being bounded by a periodic refractive index perturbation, such as a fiber Bragg grating forming an interferometer, similar to a Fabry-Perot optical cavity. The optical fiber sections of the acoustic sensor of the present invention are perturbed by acoustic signals. When an acoustic signal impinges upon a sensor section, the acoustic signal causes strain in the optical fiber. The strain causes the optical path length of the fiber in the interferometer to change, thereby causing a phase change in the light. This phase change results in a change in the optical intensity of the light returned to the electronic equipment located at the well head. The intensity change may be detected and analyzed by suitable electronic equipment, such as, for example, an interrogator, which may also include a suitable processor programmed by appropriate software, or other appropriate analysis means.

In still another aspect, an acoustic sensor in accordance with the present invention is used to monitor the sound profile present within the bore of a well. When sand invades the well bore, the sound profile present within the well bore is changed. This change is detected by the acoustic sensor of the present invention, analyzed and identified by suitable electronics, and an alert or visual display provided to the well operators so that appropriate action to prevent damage to the well and its equipment may be taken.

In yet another aspect, the present invention provides an unobtrusive acoustic sensor capable of being mounted on the outside of a well casing. In this aspect, the acoustic sensor is capable of detecting acoustic events occurring within the well bore while located outside of the bore and out of the fluid stream.

Other features and advantages of the invention will be come apparent from the following detailed description, taken in conjunction with the accompanying drawings, which illustrate, by way of example, the features of the invention.

### BRIEF DESCRIPTION OF THE DRAWINGS

FIG. 1 is a side cross-sectional view of one embodiment of a downhole sand detector with multiple acoustic sensor zones formed in an optical fiber in accordance with the present invention.

FIG. 2 is a side cross-sectional view showing the deployment of the acoustic sensor in accordance with the embodiment depicted in FIG. 1 in a well.

FIG. 3a. is an enlarged side view showing the acoustic sensor of FIG. 1 deployed in the producing section of a well within an instrumentation tubing.

FIG. 3b is an enlarged side view showing the acoustic sensor of FIG. 1 encased in coil tubing and deployed in the oil producing section of a well.

FIG. 4 is a graphical schematic showing a remotely deployed fiber sensor array in accordance with the embodiment depicted in FIG. 1 in optical communication with equipment located at the well head for generating light pulses transmitted to the sensor array and for analyzing the pulses of light returned by the sensor array.

FIG. 5a is a graphical representation of an analysis of the return pulses generated by a sensor as depicted in FIG. 1 depicting changes of output versus time.

FIG. 5b is a graphical representation of an analysis of the return pulses generated by a sensor as depicted in FIG. 1 depicting the frequency content of the returned signal.

FIG. 6a is a graphical representation illustrating a time domain analysis of the acoustic signature detected by the sensor of FIG. 1 of a rebar wire break.

FIG. 6b is a graphical representation illustrating a time domain analysis of the acoustic signature detected by the sensor of FIG. 1 of a hammer blow on a precompressed concrete pipe.

FIG. 7a. is a graphical representation illustrating a frequency domain analysis of the acoustic signature detected by the sensor of FIG. 1 of a rebar wire break.

FIG. 7b is a graphical representation illustrating a frequency domain analysis of the acoustic signature detected by the sensor of FIG. 1 of a hammer blow on a precompressed concrete pipe.

### DETAILED DESCRIPTION OF THE INVENTION

In its broadest aspect, the present invention is embodied in a system utilizing an optical fiber having one or more fiber Bragg grating sensors formed therein for detecting acoustic signals. The present invention is particularly useful for detecting acoustic signals originating in well holes, and thus provides a means for detecting changes in the acoustic profile of the well caused by the invasion of sand into the well bore.

In one embodiment of the present invention, the optical fiber includes an array of sections of the optical fiber with each section of optical fiber being separated by fiber gratings having a selective reflectivity at predetermined wavelength. In this manner, the an array of acoustic sensors is provided with each segment of the array sensitive to acoustic energy, In this embodiment, each of the segments of the array may be used to detect sand invasion over a segment, or zone, of the well. One advantage of the design of the present invention is that it allows the acoustic sensor of the present invention to be mounted outside of the well pipe, out of the fluid stream. Such a mounting is thus unobtrusive, and does not interfere with the deployment or removal of the well's production pipe stream or other well equipment from the well pipe or bore.

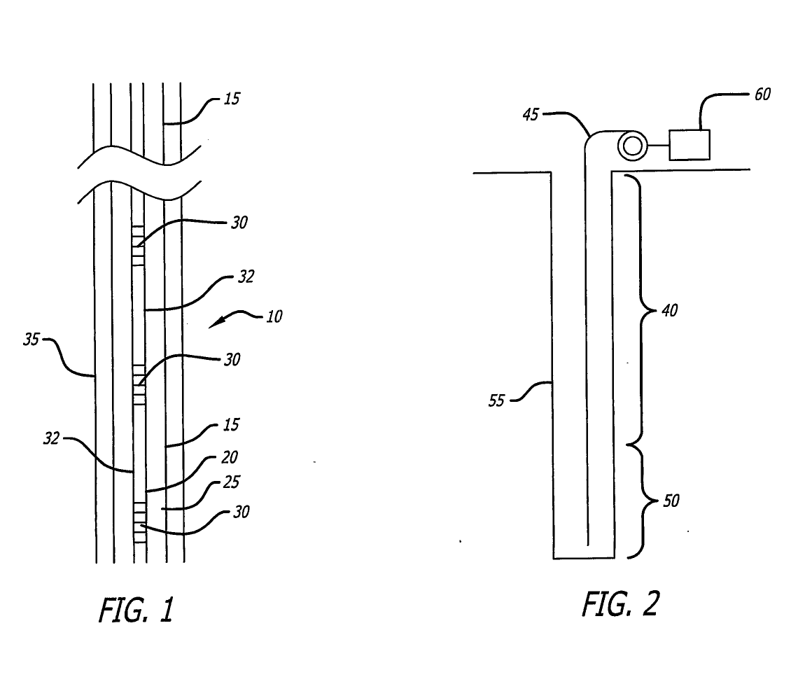

FIG. 1 illustrates one embodiment of the present invention, wherein the downhole acoustic sand sensor 10 comprises an optical fiber 15 having core 20 and cladding 25. Optical fiber 20 may also include additional coatings or protective layers as desired.

One or more fiber Bragg gratings 30 are formed within the fiber 15 using methods known to those skilled in the art at specified intervals along a section of optical fiber 15 that is to be located within the production area of a well, such as, for example, the methods described in U.S. Pat. No. 6,222,973, Fabrication of Refractive Index Patterns in Optical Fibers Having Protective Optical Coatings, issued Apr. 24, 2001, and hereby incorporated by reference herein in its entirety. Each fiber Bragg grating 30 forms a boundary of an acoustic sensing section 32 of the acoustic sand detector 10. The lengths of the sensors, as determined by the spacing between the fiber Bragg gratings, may range from several meters to 100 meters or more.

In principle, fiber Bragg gratings act as partially refractive mirrors within the optical fiber. The optical mirrors provided by the fiber Bragg grating may also be provided using other means, such as, for example, by incorporating one or more Fabry-Perot optical cavities into the optical fiber.

The fiber between the fiber Bragg gratings forms one leg of an interferometer that is very sensitive to acoustic signals. Acoustic signals encountering the acoustic sensing sections 32 apply strain to the optical fiber 15 of acoustic sensing section 32, changing the optical path length of the optical fiber 15 within the sensing section 32. This change in optical path length, in cooperation with the partially reflective mirrors of the fiber Bragg grating, results in a change in the amplitude of the optical signal returned to the interrogation electronics.

The sensor 10 may be deployed in a well within a tube 35 to provide protection from the downhole environment. It has been observed by the inventors that the acoustic sensitivity of the acoustic sensing section 32 of the sand detector 10 is not seriously degraded by protecting the fiber in this manner.

FIG. 2 provides an illustration showing the deployment of an optical fiber sensor cable having one or more acoustic sensing sections or zones within a well bore.

Sensor cable 45 comprising a lead cable portion 40 and an acoustic section sensing section 50 is shown deployed in a well bore 55. The sensor cable 45 may be deployed down well bore 55 using methods well known to those skilled in the art that allow for deployment and removal of the sensor cable 45 and acoustic section 50 from the well bore 55.

At the well head, the sensor cable is connected to an optical interrogator 60. The optical interrogator 60 provides a beam of light that is transmitted down the sensor cable. The optical interrogator 60 is also used to analyze the phase change of the light returned by the acoustic sensing section 50.

As described above, the acoustic sensor array 50 shown in FIG. 2 may comprise one or more zones which are determined by the spacing between the fiber Bragg gratings. The sensor lengths may be on the order of several meters to 100 meters or more in length. In one typical deployment strategy, the acoustic sensing array 50 is deployed into well bore 55 using a lead cable 40. Such a lead cable 40 may be up to 12 kilometers or more in length, depending on the depth of the well or the depth at which acoustic sensing is desired.

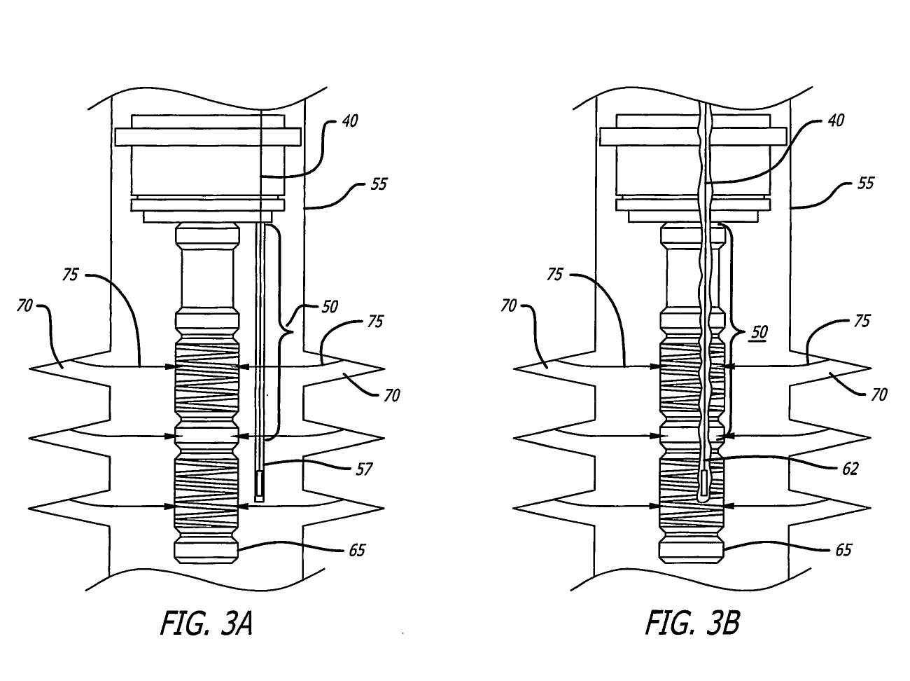

FIG. 3A is a graphical illustration of the deployment of the acoustic sensor section 50 in the production area of well bore 55. As shown in FIG. 3A, acoustic sensor section 50 may be deployed in well bore 55 either through existing instrumentation tubing 57, made from a suitable material such as stainless steel or other suitable material. This illustration shows the placement of the sensor array in the production area of the well where oil 75 seeps or flows from fractures 70 of the surrounding rock, often carrying sand along with the flow into the inlet 65 of the well pipe. Alternatively, as depicted in FIG. 3B, the acoustic sensor array 50 may be deployed in the well bore 55 deployed using coil tubing 62.

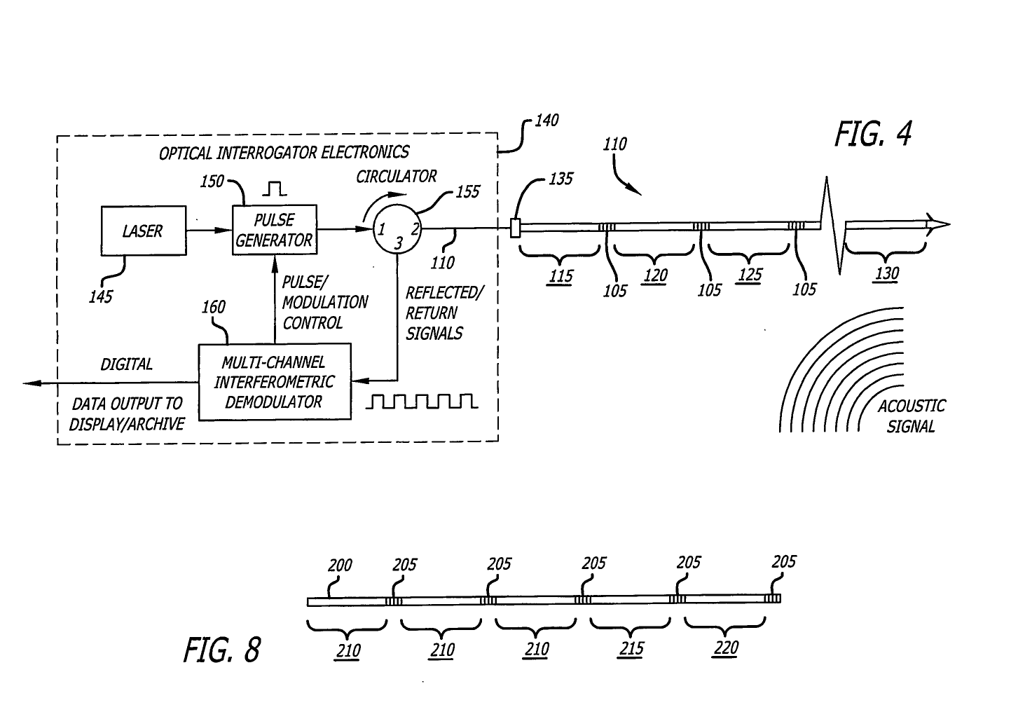

FIG. 4 depicts an embodiment of the present invention illustrating one manner of analyzing the signals received from a remotely deployed fiber sensor array. In this embodiment, an array of reflective gratings 105 are formed in an optical fiber 110. The fiber Bragg gratings 105 are formed in such a manner so as to have the same reflective wavelength. As previously described, the sections of optical fiber extending between the gratings 105 form the individual acoustical sensors 115, 120, 125, 130 in the fiber sensor array. It will be understood that while four sensor sections are illustrated, more or fewer sections may be used without departing from the scope of the invention.

As shown in FIG. 4, the remotely deployed fiber sensor array having a plurality of fiber acoustic sensors 115, 120, 125, 130 is connected by means of an optical connector 135 to an optical interrogator 140 or other electronic equipment for analyzing the returned light. In this illustrative embodiment, a light beam is provided by a laser 145. The laser light is modulated into a pulse by a pulse generator 150 controlled by a pulse/modulation controller. After modulation, the modulated pulse of light is then provided to a circulator 155, which sends the modulated pulse of light down the optical fiber 110 to the sensor. The pulse/modulation controller, pulse generator 150 and laser 145, are all well known in the art, and will not be described here.

Low reflectance fiber Bragg gratings act as partial reflectors such that a single pulse out of the circulator 155 and into the fiber 110 results in a return series of N-pulses back to the circulator 155 where N is proportional to the number of fiber gratings 105 in the remotely deployed fiber sensor array. Light passing through the individual sensors 115, 120, 125, 130 undergoes a phase shift based upon the presence or absence of an acoustic signal.

Multiple reflected return pulses are transmitted up the optical fiber 110 through the optical connector 135 and into the circulator 155, which redirects the reflected/return signals to a multi-channel interferometric demodulator 160. The multiple return pulses are thus processed and converted to a digital electronic signal for data output to a display or into a suitable storage medium for later analysis by a suitably programmed processor. Alternatively, the digital electronic signal representative of the multiple return pulses may be processed using a suitable processor programmed with appropriate software in a real-time fashion to provide a visible display, audible alert, or other suitable report reflecting the integrity of the well stream.

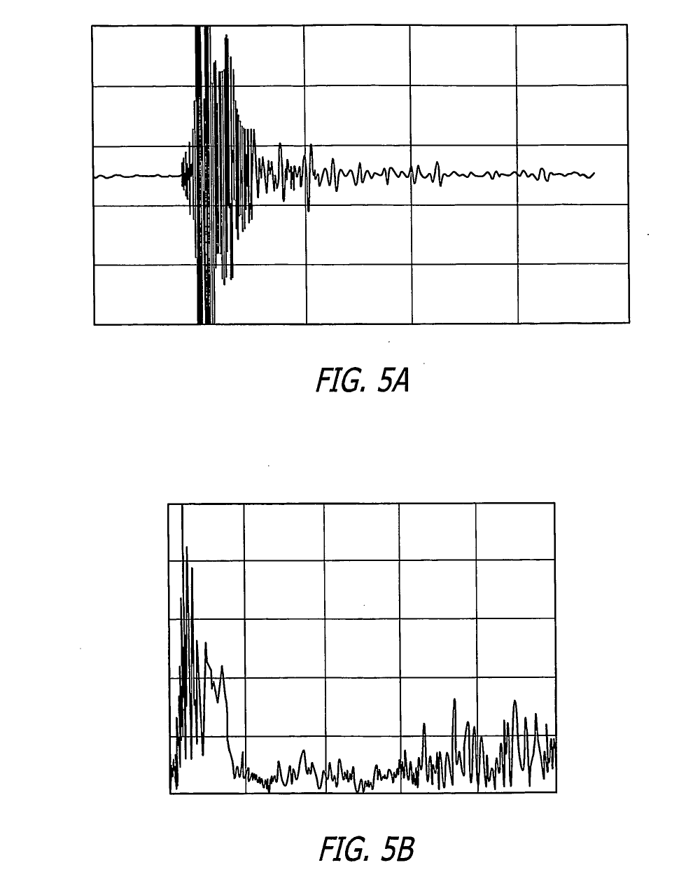

FIGS. 5A and 5B are graphical representations of two different analysis modes that can be applied to an acoustical signal detected by a remotely deployed fiber sensor array in accordance with the present invention. For example, FIG. 5A depicts the change of output of the acoustic sensor as a function of time. FIG. 5B depicts a frequency domain analysis of the same signal, showing the frequency content of the signal. Since both of these analysis are well known to those skilled in the art, the details of such analysis need to be described here. The choice of which analysis type to use is a matter of choice, depending on the information desired to be provided by the analysis.

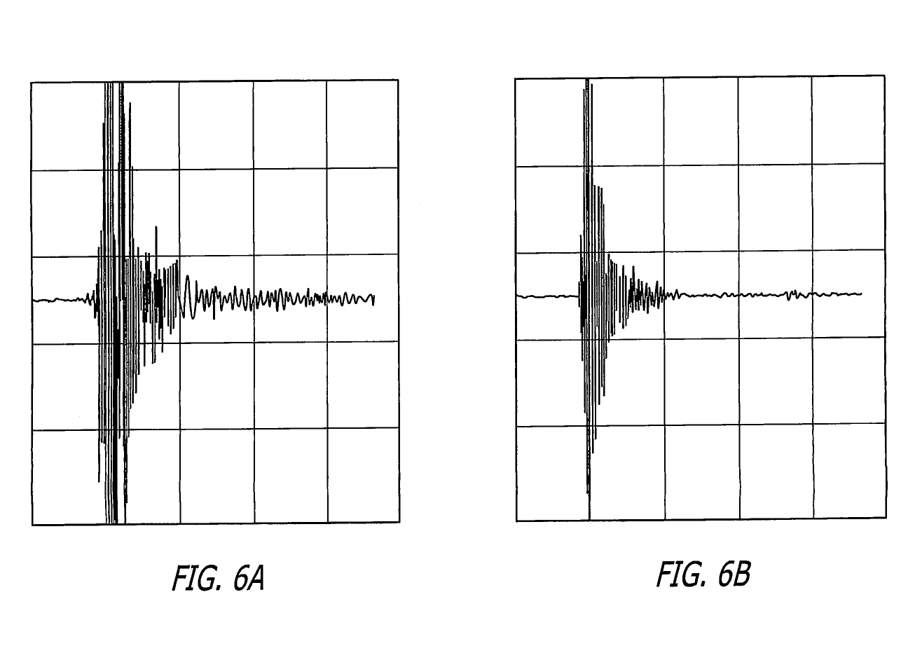

However, depending on the information being sought, one analysis of another may prove more useful in determining the cause of an acoustic event. For example, FIGS. 6A and 6B are graphical representations of an analysis in the time domain of the acoustical signals received by a remotely deployed fiber sensor array. FIG. 6A shows the time domain analysis of the acoustic signal received by the remote fiber sensor after a rebar wire break in a precompressed concrete pipe. FIG. 6B shows a similar signal received after a hammer blow on the precompressed concrete pipe. Although the time domain graphs show some differences between the acoustic signatures of the two events, it is apparent that analyzing signals in the time domain may not always be preferable in that different sources may provide similar acoustic signatures.

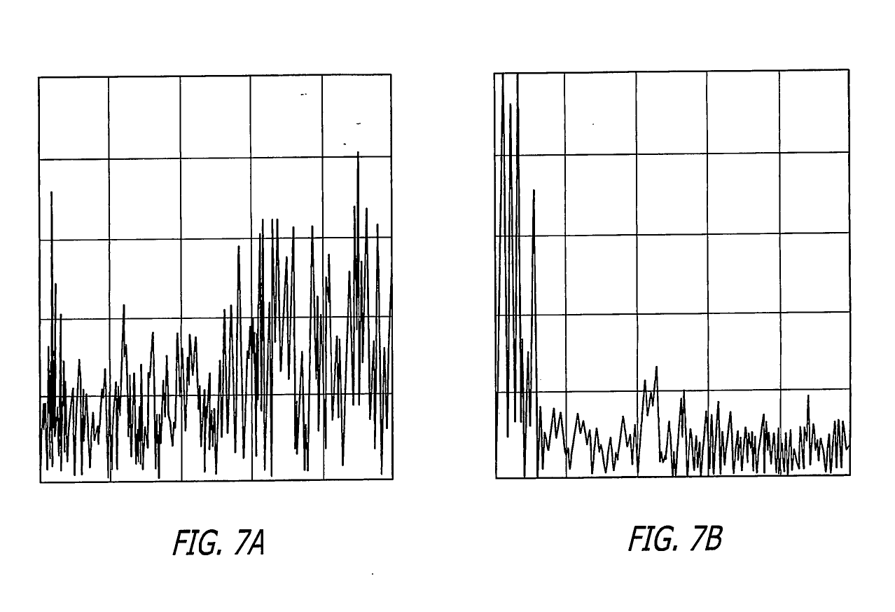

In some cases, it may be more advantageous to analyze the frequency domain of acoustic signals received from the remotely deployed fiber sensor of the present invention, as illustrated by the graphs of FIGS. 7A and 7B. FIG. 7A depicts a frequency plot of the acoustic signal provided by a remotely deployed fiber optic sensor of the present invention of the rebar wire break in the precompressed concrete pipe. This graph may be compared to the graph of FIG. 7B which illustrates the frequency plot of the acoustic signal received from the remotely deployed fiber sensor after a hammer blow is applied to the precompressed concrete pipe. Comparing FIGS. 7A and 7B, it is easily seen by analyzing the frequency domain that the acoustical signatures of different events may be easily identified.

The present invention thus provides a system for detecting the invasion of sand into a well bore by analyzing signals received from a remotely deployed fiber optic fiber sensor array. Using either time domain or frequency domain analysis, the acoustic signal may be characterized to determine whether the acoustic signal is caused by the invasion of sand into the well bore, or by some other event that may or may not require attention by the well operator. Analysis of the signals may also be used to separate acoustical signals representing noise typical of well operation, such as machinery noise, noise from surface equipment, trucks, and other noise typical of an operating well, from noise generated by the invasion of sand into the fluid stream of the well.

One added advantage of the fiber sensor array of the present invention is that the acoustic sensor sections (FIG. 4) may be formed on the same optical fiber as other detectors, such as downhole temperature sensors. One example of such a system is illustrated in FIG. 8. Fiber 200 has several fiber gratings 205 formed therein. Sensor sections 210 may be formed as acoustic sensors in the manner described above. Sections 215 and 220 may be formed as temperature sensors or pressure sensors and the like. Such sensors utilize similar technology to the sensors forming the acoustic sensor array, but are designed to detect changes in reflected light as a function of changes in temperature, pressure, or some other parameter.

Utilizing remotely deployed fiber sensors of the present invention is also advantageous in that multiple sensors or sensor arrays can be deployed on the same fiber in order to listen to two or more distinct zones in a well. For example, such an embodiment would be particularly useful in a well that is extracting oil from several strata that are separated by tens to hundreds of feet. In one embodiment, the center wavelength of the Bragg gratings in separate sections of the remotely deployed sensor array may be changed so that analysis of the return signals can separate the signals to determine where the signals originated within the well. Sensors with gratings of the same central wavelength are interrogated using a time division multiplexing approach.

Because the remotely deployed fiber acoustic sensor of the present invention capable of detecting any acoustic signal within the well bore, the remotely deployed fiber sensor may also serve other functions besides monitoring for the invasion of sand. For example, the remotely deployed sensor array of the present invention may be used to monitor the well for any change in the sound profile of the well. For example, the present invention is capable of detecting changes in the frequency spectrum of the sound emanating from a downhole pump. Such changes may indicate the onset of failure of the pump.

Although particular forms of the invention have been illustrated and described, it will be apparent that various modifications can be made without departing from the spirit and scope of the invention.

We claim:

1. A sensor for detecting acoustical signals in the bore of a well, comprising:
an optical fiber having a core and a cladding; and
at least one periodic refractive index perturbation formed within the optical fiber.

2. A remotely deployable acoustic sensing array for detecting acoustic signals in a well bore comprising:
an optical fiber having a core and a cladding layer; and
a plurality of periodic refractive index perturbations formed at selected intervals along a selected length of the optical fiber.

3. The device of claim 2, wherein the periodic refractive index perturbations is a Bragg grating.

4. A system for detecting acoustic signals in the producing area of a well bore, comprising:
an optical fiber having a core and a cladding layer;
at least one periodic refractive index perturbation formed in the optical fiber at a location of the fiber to be deployed in the producing area of a well;
an optical interrogator in optical communication with the optical fiber, the optical interrogator for transmitting light down the optical fiber and for receiving light reflected by the at least one periodic refractive index perturbation formed within the fiber.

5. The system of claim 4, further comprising a processor programmed to analyze the reflected light to provide a signal representative of the presence of a detected acoustic signal.

6. The system of claim 4, wherein the at least one periodic refractive index perturbation and a selected length of optical fiber form an acoustic sensor.

7. The system of claim 6, wherein the acoustic sensor is configured to be mounted on an external side of a well casing.
